(19) United States
(12) Patent Application Publication
(10) Pub. No.: US 2026/0265501 A1
(43) Pub. Date: Sep. 10, 2026

(54) POLYMER COMPOSITION FOR AUTOMOTIVE INTERIOR SKIN AND AUTOMOTIVE INTERIOR SKIN MANUFACTURED USING THE SAME

(71) Applicants: Hyundai Motor Company, Seoul (KR); Kia Corporation, Seoul (KR)

(72) Inventors: Chanwook Park, Hwaseong (KR); Yong Tae Joo, Hwaseong (KR); Jaesik Seo, Hwaseong (KR)

(21) Appl. No.: 19/219,241

(22) Filed: May 27, 2025

(30) Foreign Application Priority Data
Mar. 4, 2025 (KR) 10-2025-0027263

(51) Int. Cl. C08K 13/02; C08J 3/20; C08K 3/06; C08K 3/22; C08K 5/09; C08K 5/18; C08K 5/3437; C08K 5/40; C08K 5/47

(52) U.S. Cl. CPC C08K 13/02; C08J 3/203; C08K 3/06; C08K 3/22; C08K 5/09; C08K 5/18; C08K 5/3437; C08K 5/40; C08K 5/47; C08J 2323/16; C08K 2003/2296; C08K 2201/005

(57) ABSTRACT

The present disclosure relates to a polymer composition, a method of preparing the polymer composition, and an automotive interior skin manufactured using the same. The polymer composition for automotive interior skin according to embodiments of the present disclosure may be environmentally friendly due to its bio-content of 30 weight % or more. The automotive interior skin manufactured using the polymer composition for automotive interior skin may exhibit improved mechanical properties and may exhibit a characteristic appearance of naturally derived materials, resulting in improved aesthetics. The invention supports environmental friendliness and expanded utilization of mushroom-industry byproducts as valuable raw materials, delivering a sustainable automotive interior skin with superior processability and performance.

### CROSS-REFERENCE TO RELATED APPLICATION

This present application claims under 35 U.S.C. § 119(a) the benefit of priority to Korean Patent Application No. 10-2025-0027263, filed on Mar. 4, 2025, in the Korean Intellectual Property Office, the entire disclosure of which is incorporated herein by reference.

### BACKGROUND

### Technical Field

The present disclosure relates to a polymer composition for automotive interior skin and automotive interior skin manufactured using the same.

### Background

Recently, with the rapid increase in interest in environmental protection, research and development on eco-friendly materials have been actively conducted. Accordingly, the development of bio-based materials that can replace existing petroleum compound-based materials is emerging as an important task.

In the mushroom cultivation industry, a large amount of spent mushroom substrate is generated, excluding the edible portion. As of 2020, approximately 800,000 tons of spent mushroom substrate were discharged annually. While about 17% of this material is recycled as compost, the remainder is typically discarded. This spent mushroom substrate is a biomass composite comprising some mycelium formed by the growth of mushrooms, sawdust, and rice bran, and is expected to play an important role in terms of environmental protection and resource recycling, creating a need for research into its effective utilization.

The matters described in this Background section are only for the enhancement of understanding of the background of the disclosure, and should not be taken as acknowledgement that they correspond to existing technologies already known to those skilled in the art.

### SUMMARY

The following summary presents a simplified summary of certain features. The summary is not an extensive overview and is not intended to identify key or critical elements.

The present disclosure is directed to providing a polymer composition for automotive interior skin with a high bio-content.

The present disclosure is further directed to providing automotive interior skin manufactured from the polymer composition that exhibits improved mechanical properties and aesthetics.

The present disclosure is further directed to providing a polymer composition for automotive interior skin applicable to green technology fields such as eco-friendly automobiles.

Some embodiments of the present disclosure may provide a polymer composition for automotive interior skin, the polymer composition including a mushroom substrate powder, a polymer resin, stearic acid, a metal oxide, and a processing oil. The mushroom substrate powder may be a spent mushroom substrate powder.

The polymer composition for automotive interior skin according to one embodiment may further include one or more selected from the group consisting of shaving scrap, an antioxidant, sulfur, and a vulcanization accelerator.

The spent mushroom substrate powder according to one embodiment may include, based on a total weight of the spent mushroom substrate powder, 65 to 85 weight % of sawdust, 5 to 20 weight % of rice bran, 5 to 20 weight % of wheat bran, 0.1 to 5 weight % of glucose, 0.01 to 1 weight % of calcium, and 0.01 to 1 weight % of shell powder.

The spent mushroom substrate powder according to one embodiment may have a cellulose content of 25 to 60 weight % based on the total weight of the spent mushroom substrate powder.

The spent mushroom substrate powder according to one embodiment may have an average particle size of 0.1 to 5 mm.

The polymer resin according to one embodiment may include one or more selected from the group consisting of ethylene propylene rubber (EPDM), ethylene vinyl acetate (EVA), polypropylene (PP), polyethylene terephthalate (PET), and thermoplastic elastomer (TPE).

The polymer composition for automotive interior skin according to one embodiment may include, based on 100 parts by weight of the spent mushroom substrate powder, 50 to 500 parts by weight of the polymer resin, 1 to 10 parts by weight of the stearic acid, 1 to 30 parts by weight of the metal oxide, and 5 to 50 parts by weight of the processing oil.

The polymer composition for automotive interior skin according to one embodiment may further include, based on 100 parts by weight of the spent mushroom substrate powder, 50 to 200 parts by weight of the shaving scrap, 1 to 10 parts by weight of the antioxidant, 0.5 to 10 parts by weight of sulfur, and 0.1 to 5 parts by weight of the vulcanization accelerator.

Another aspect of the present disclosure may provide automotive interior skin manufactured from the polymer composition for automotive interior skin.

The polymer composition for automotive interior skin according to embodiments of the present disclosure may be environmentally friendly due to its bio-content of 30 weight % or more.

The automotive interior skin according to embodiments of the present disclosure may exhibit improved mechanical properties.

The automotive interior skin according to embodiments of the present disclosure may exhibit a characteristic appearance of naturally derived materials, resulting in improved aesthetics.

In some embodiments, a method of preparing a polymer composition for an automotive interior skin is provided. The method includes pulverizing a mushroom substrate to obtain a mushroom powder having an average particle size of about 0.1 to 5 mm, mixing the mushroom substrate powder with a polymer resin, stearic acid, a metal oxide, and a processing oil in amounts corresponding to 100 parts by weight of the spent mushroom substrate powder, about 50 to 500 parts by weight of the polymer resin, about 1 to 10 parts by weight of the stearic acid, about 1 to 30 parts by weight of the metal oxide, and about 5 to 50 parts by weight of the processing oil to form a resulting mixture, and forming the resulting mixture into a polymer composition.

The mixture may further include one or more selected from the group consisting of shaving scrap, an antioxidant, sulfur, and a vulcanization accelerator, in amount corresponding to 100 parts by weight of the mushroom substrate powder, about 50 to 200 parts by weight of the shaving scrap, about 1 to 10 pars by weight of the antioxidant, about 0.5 to 10 parts by weight of sulfur; and about 0.1 to 5 parts by weight of the vulcanization accelerator.

The mushroom substrate powder may be a spent mushroom substrate powder. The spent mushroom substrate powder may include, based on a total weight of the spent mushroom substrate powder: about 65 to 85 weight % of sawdust, about 5 to 20 weight % of rice bran, about 5 to 20 weight % of wheat bran, about 0.1 to 5 weight % of glucose, about 0.01 to 1 weight % of calcium, and about 0.01 to 1 weight % of shell powder.

The mushroom substrate powder may have a cellulose content of about 25 to 60 weight % based on a total weight of the mushroom substrate powder.

In some embodiments, provided is an automotive interior skin manufactured by: obtaining a polymer composition by the method of claim 11, and molding or forming the polymer composition to produce the automotive interior skin.

The automotive interior skin may include about 1 to 50 weight % of the mushroom substrate powder based on the total weight of the automotive interior skin.

The mushroom substrate may be a spent mushroom substrate. The polymer composition may further include about 50 to 200 parts by weight of shaving scrap. The polymer resins may be one or more selected from the group consisting of ethylene propylene rubber (EPDM), ethylene vinyl acetate (EVA), polypropylene (PP), polyethylene terephthalate (PET), and thermoplastic elastomer (TPE).

As discussed, the method and system suitably include use of a controller or processer.

In another embodiment, vehicles are provided that comprise an apparatus as disclosed herein.

Effects of the present disclosure are not limited to the above-mentioned effects, and other effects, not mentioned above, will be clearly understood by those skilled in the art from the following description.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 shows photographs of various forms of spent mushroom substrate, according to some embodiments of the present disclosure.

FIG. 2 shows graphs showing a particle distribution of a spent mushroom substrate powder according to the mesh size of a cutting mill, according to some embodiments of the present disclosure.

FIG. 3 shows measurement results of the permanent compression set of automotive interior skins manufactured according to examples of the present disclosure and comparative examples.

FIG. 4 shows measurement results of hardness (left) and hardness after aging (right) of automotive interior skins manufactured according to examples of the present disclosure and comparative examples.

FIG. 5 shows measurement results of tensile strength (left) and tensile strength after aging (right) of automotive interior skins manufactured according to examples of the present disclosure and comparative examples.

### DETAILED DESCRIPTION

Hereinafter, the present disclosure will be described in more detail. However, the following embodiments are provided merely as references for describing the present disclosure in detail, and the present disclosure is not limited thereto and may be implemented in various forms

Unless otherwise defined, all technical and scientific terms used herein have the same meaning as commonly understood by those skilled in the art to which the present disclosure pertains.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The following provides a more detailed description of the present disclosure.

An aspect of the present disclosure may provide a polymer composition for automotive interior skin, the polymer composition including a spent mushroom substrate powder, a polymer resin, stearic acid, a metal oxide, and a processing oil.

Spent mushroom substrate refers to a byproduct comprising mushroom mycelium remaining after mushroom cultivation and organic matter in which mushroom mycelium can grow.

The term “polymer resin” herein refers to one or more thermoplastic or elastomeric materials capable of forming a polymer matrix.

The term “processing oil” herein refers to an oil or oil-based additive that improves the processability, flexibility, or workability of the polymer composition.

The term “vulcanization accelerator’” herein refers to a compound that speeds or otherwise aids the crosslinking reaction (vulcanization) in sulfur-containing polymer compositions.

The term “average particle size” herein refers to the median or mean diameter of particles in a powdered composition, typically determined by standard test methods such as sieve analysis or laser diffraction.

The term “cellulose content” herein refers to the percentage of cellulose in the mushroom substrate (or other biomass), measured by analytical methods, relative to the total dry weight of the substrate powder.

In one embodiment, the spent mushroom substrate may be a spent substrate of one or more mushrooms selected from the group consisting of shiitake mushroom, reishi mushroom, oyster mushroom, button mushroom, king oyster mushroom, and enoki mushroom. Specifically, since the substrate components vary depending on the mushroom type, considering compatibility and dispersibility with the polymer resin, shiitake mushroom spent substrate may be more preferable.

In one embodiment, the solid content of the spent mushroom substrate may be 25 to 75 weight %, specifically 30 to 70 weight %, more specifically 60 to 70 weight %, but is not limited thereto as long as the objects of the present disclosure can be achieved.

In one embodiment, the oil content of the spent mushroom substrate may be 0.1 to 10 weight %, specifically 0.5 to 5 weight %, more specifically 1 to 2 weight %, but is not limited thereto as long as the objects of the present disclosure can be achieved.

The spent mushroom substrate may be pulverized to improve compatibility with a resin or the like and used as spent mushroom substrate powder.

In one embodiment, the pulverization may be performed by a pulverization method selected from the group consisting of a Niagara beater, a cutting mill, a disk mill, and a ball mill, and specifically, pulverization may be performed with a cutting mill. When the cutting mill is used for pulverization, pulverization may be facilitated, the amount of finely pulverized spent substrate may be reduced, and deviation of particle size of the powder may be small.

In one embodiment, the spent mushroom substrate powder may comprise one or more selected from the group consisting of sawdust, corn cob, rice bran, wheat bran, beet, corn grits, dried soybean residue, shell powder, calcium, kapok, mixed substrate, and glucose.

In one embodiment, the spent mushroom substrate powder may comprise, based on the total weight of the spent mushroom substrate powder, 65 to 85 weight %, specifically 75 to 80 weight % of sawdust, 5 to 20 weight %, specifically 8 to 15 weight % of rice bran, 5 to 20 weight %, specifically 8 to 15 weight % of wheat bran, 0.1 to 5 weight %, specifically 0.5 to 2 weight % of glucose, 0.01 to 1 weight %, specifically 0.05 to 0.5 weight % of calcium, and 0.01 to 1 weight %, specifically 0.05 to 0.5 weight % of shell powder. When this range is satisfied, the cellulose content is high, resulting in enhanced compatibility and dispersibility with the polymer resin, and improved properties of the automotive interior skin may be secured.

In one embodiment, the spent mushroom substrate powder may have a cellulose content of 25 to 60 weight %, specifically 35 to 45 weight % based on the total weight of the spent mushroom substrate powder. When this is satisfied, the spent mushroom substrate powder may have enhanced compatibility and dispersibility with the polymer resin, and improved physical properties of the automotive interior skin may be secured.

In one embodiment, the spent mushroom substrate powder may have an average particle size of up to 5 mm, up to 3 mm, or up to 2 mm as the upper limit, and at least 0.1 mm as the lower limit. When this is satisfied, the efficiency of pulverization is enhanced, the particle size deviation is small, and the automotive interior skin may exhibit improved mechanical properties.

In one embodiment, the polymer resin may comprise one or more selected from the group consisting of ethylene propylene rubber (EPDM), ethylene vinyl acetate (EVA), polypropylene (PP), polyethylene terephthalate (PET), and thermoplastic elastomer (TPE), and specifically may comprise ethylene propylene rubber.

In one embodiment of the present disclosure, the polymer resin may be included in an amount of 50 to 500 parts by weight, specifically 100 to 200 parts by weight, based on 100 parts by weight of the spent mushroom substrate powder.

The stearic acid and the metal oxide are for increasing the rate of crosslinking reaction, and when the metal oxide and the stearic acid are used together, metallic stearate is generated to promote crosslinking.

In one embodiment of the present disclosure, the stearic acid may be included in an amount of 1 to 10 parts by weight, specifically 2 to 5 parts by weight, based on 100 parts by weight of the spent mushroom substrate powder.

In one embodiment, the metal oxide may comprise one or more selected from the group consisting of zinc oxide, magnesium oxide, and calcium oxide, but is not limited thereto as long as the objects of the present disclosure can be achieved.

In one embodiment of the present disclosure, the metal oxide may be included in an amount of 1 to 30 parts by weight, specifically 3 to 15 parts by weight, based on 100 parts by weight of the spent mushroom substrate powder.

In one embodiment of the present disclosure, the processing oil may be included in an amount of 5 to 50 parts by weight, specifically 10 to 25 parts by weight, based on 100 parts by weight of the spent mushroom substrate powder.

In one embodiment of the present disclosure, the polymer composition for automotive interior skin may further comprise one or more selected from the group consisting of shaving scrap, an antioxidant, sulfur, and a vulcanization accelerator.

The shaving scrap may refer to leather processing waste or byproduct generated by going through a shaving process for thickness adjustment after a tanning process, which is one among leather processing processes.

In one embodiment, the shaving scrap may be included in an amount of 50 to 200 parts by weight, specifically 70 to 150 parts by weight, based on 100 parts by weight of the spent mushroom substrate powder.

In one embodiment, the antioxidant may serve to effectively remove radicals generated by external factors such as oxygen, thereby preventing the oxidation of the polymer composition, and may be used without particular limitation using known antioxidants but specifically may be N-(1,3-dimethylbutyl)-N′-phenyl-p-phenylenediamine (HPPD), poly(1,2-dihydro-2,2,4-trimethylquinoline) (RD), or a combination thereof.

In one embodiment, the antioxidant may be included in an amount of 1 to 10 parts by weight, specifically 2 to 5 parts by weight, based on 100 parts by weight of the spent mushroom substrate powder. When this is satisfied, a blooming phenomenon does not occur, and improved physical properties of the skin may be secured.

The sulfur is for imparting rigidity to the polymer composition.

In one embodiment, the sulfur may be included in an amount of 0.5 to 10 parts by weight, specifically 1 to 5 parts by weight, based on 100 parts by weight of the spent mushroom substrate powder. When this range is satisfied, crosslinking flexibility may be improved.

The vulcanization accelerator is for imparting physical properties to the skin when mixed with the sulfur. In one embodiment, the vulcanization accelerator may use thiazole-based, thiuram-based, sulfenamide-based, or the like as needed, and specifically may use N-cyclohexyl-2-benzthiazole sulfonamide (CZ), tetramethylthiuram disulfide (TT), or a combination thereof.

In one embodiment, the vulcanization accelerator may be included in an amount of 0.1 to 5 parts by weight, specifically 1 to 3 parts by weight, based on 100 parts by weight of the spent mushroom substrate powder. When this range is satisfied, color adjustment is facilitated, and improved physical properties may be exhibited by securing sufficient scorch time.

Another aspect of the present disclosure may provide automotive interior skin manufactured from the polymer composition for automotive interior skin.

The automotive interior skin may be manufactured using methods known in the art without limitation.

Hereinafter, various examples of the present disclosure are described. However, the following examples are merely various examples of the present disclosure, and the present disclosure is not intended to be limited thereto.

### Example 1

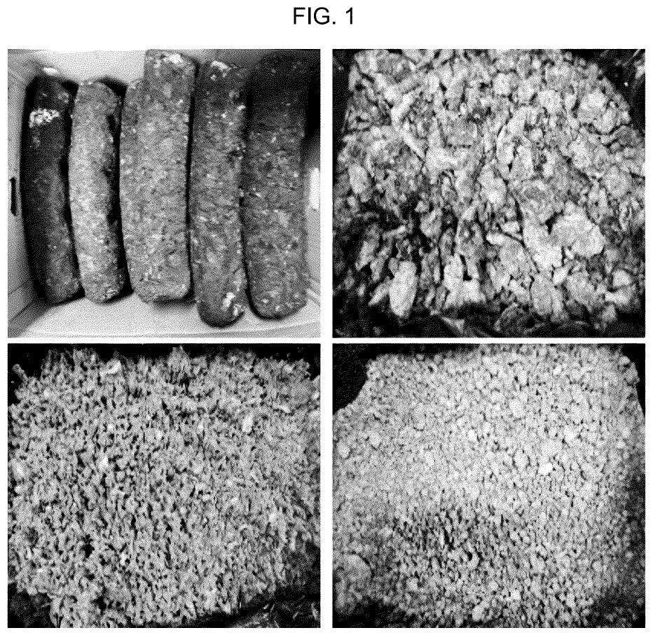

As shown in FIG. 1, spent shiitake mushroom substrate was pulverized with a cutting mill with a mesh size set to 1 mm to obtain a spent mushroom substrate powder. The spent shiitake mushroom substrate was composed of 78.8 weight % sawdust, 10.0 weight % rice bran, 10.0 weight % wheat bran, 1.0 weight % glucose, 0.1 weight % calcium, and 0.1 weight % shell powder, and had a solid content of 64%, an oil content of 1.5%, and a cellulose content of 42%.

200 g of the spent mushroom substrate powder, 200 g of EPDM (KEP2480, Kumho Polychem), 4 g of stearic acid, 10 g of zinc oxide, 20 g of processing oil, 2 g of RD, 2 g of HPPD, 2 g of sulfur, 1.5 g of CZ, and 1 g of TT were added to a kneader and shear-mixed by blade rotation to prepare a polymer composition for automotive interior skin.

The polymer composition for automotive interior skin was primarily molded through a roll press process, and then automotive interior skin was manufactured through a heat press process.

### Examples 2 to 6

The same procedure as in Example 1 was carried out, except that the components and contents were set as described in Table 1 to prepare the polymer composition for automotive interior skin.

### Comparative Examples 1 to 6

The same procedure as in Example 1 was carried out, except that 20% aqueous solution of aluminum sulfate was added in the amount described in Table 1.

TABLE 1

| | Example | | | | | | Comparative Example | | | | | |
|---|---|---|---|---|---|---|---|---|---|---|---|---|
| | 1 | 2 | 3 | 4 | 5 | 6 | 1 | 2 | 3 | 4 | 5 | 6 |
| EPDM | 100 | | | | | | | | | | | |
| Spent mushroom | 100 | | | 50 | | | — | | | | 100 | 50 |
| substrate | | | | | | | | | | | | |
| Shaving scrap | 0 | | | 50 | | | — | | | | — | 50 |

| Stearic acid | | 2 |
|---|---|---|
| Metal oxide | | 5 |
| (ZnO) | | |
| Processing oil | | 10 |
| Antioxidant | RD | 1 |
| | HPPD | 1 |

| | | | | | | | | | | | | |
|---|---|---|---|---|---|---|---|---|---|---|---|---|
| Sulfur | 1 | 1.5 | 2 | 1 | 1.5 | 2 | — | 1 | 1.5 | 2 | — | — |

| | | |
|---|---|---|
| Vulcanization | CZ | 0.75 |
| accelerator | TT | 0.5 |

Unit: Parts by weight

### Experimental Example 1: Verification of Pulverization Efficiency

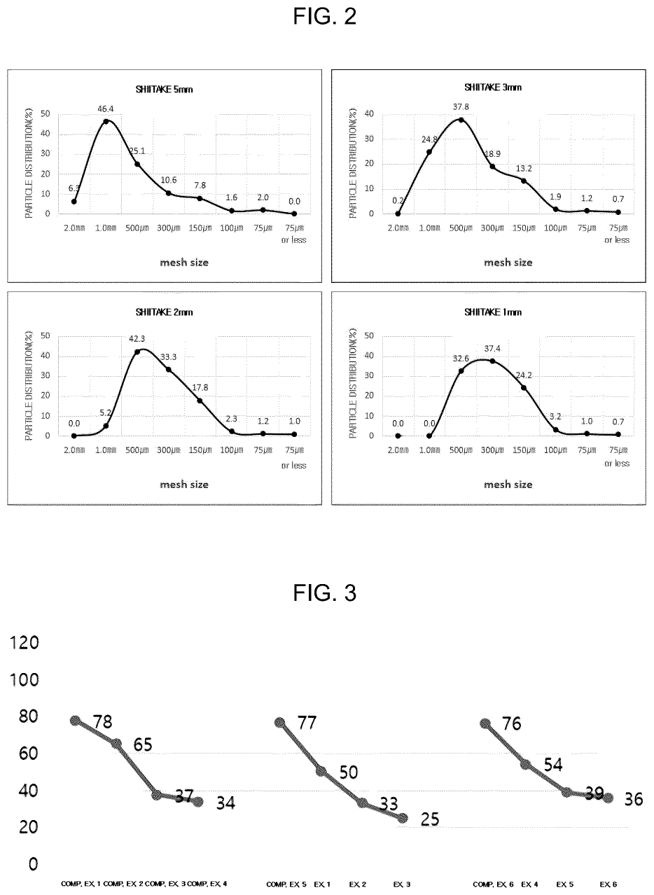

To verify the pulverization efficiency of the spent mushroom substrate, the particle distribution of spent mushroom substrate powder obtained by pulverizing with the cutting mill's mesh size set to 1, 2, 3, 5 mm respectively was measured, and the results are shown in FIG. 2.

As can be seen from FIG. 2, with mesh sizes of 5 mm and 3 mm, the particle size deviation was relatively large, and many large particles existed. However, with mesh sizes of 2 mm and 1 mm, the particle size distribution was relatively uniform, and the increase in fine particles reduced the deviation. Through this, it can be seen that setting the mesh size to 1-2 mm results in improved pulverization efficiency.

### Experimental Example 2: Measurement of Skin Physical Properties

To verify how the components and content included in the polymer composition for automotive interior skin affect the physical properties of the automotive interior skin, physical properties were measured by the following described below, and the results are shown in FIGS. 3 to 5.

### Physical Property Measurement Methods

(1) Permanent compression set (unit: %): Measured based on ISO 815-1 (100° C./22 hours compression)
(2) Hardness, hardness after aging (Shore A): Measured based on ISO 7619-1, ISO 18898, ISO 188
(3) Tensile strength, tensile strength after aging (unit: kgf/cm²): Measured based on ISO 37, ISO 188

As can be seen from FIG. 3, automotive interior skins manufactured according to Examples 1 to 3 comprising spent mushroom substrate powder and Examples 4 to 6 comprising spent mushroom substrate powder and shaving scrap showed mostly improved permanent compression set levels compared to automotive interior skins manufactured according to Comparative Examples 2 to 4 using EPDM alone under the same conditions.

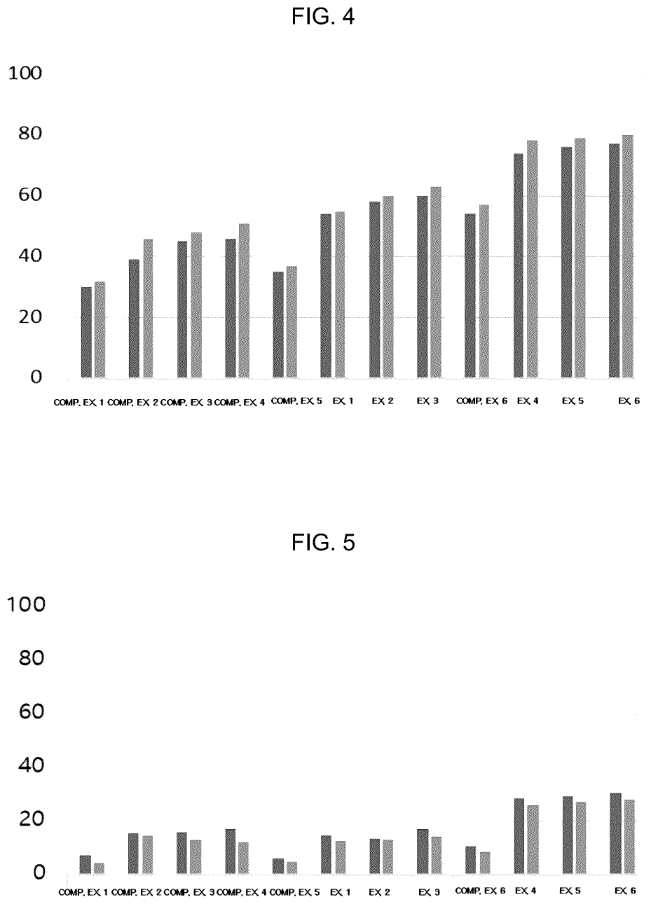

As can be seen from FIG. 4, automotive interior skins manufactured according to Examples 1 to 3 comprising spent mushroom substrate powder and Examples 4 to 6 comprising spent mushroom substrate powder and shaving scrap showed higher hardness and hardness after aging compared to automotive interior skins manufactured according to Comparative Examples 2 to 4 using EPDM alone under the same conditions. Through this, it was confirmed that the automotive interior skins comprising spent mushroom substrate powder not only show an appropriate level of hardness for use in automotive interior skin but are also particularly suitable for use as materials requiring high hardness.

As can be seen from FIG. 5, automotive interior skins manufactured according to Examples 1 to 3 comprising spent mushroom substrate powder showed similar levels of tensile strength compared to the comparative examples without it, and automotive interior skins manufactured according to Examples 4 to 6 comprising additional shaving scrap showed higher tensile strength compared to the comparative examples without it. Through this, it can be seen that the automotive interior skin according to the present disclosure may secure at least the same level of tensile strength as existing automotive interior skins, and it was confirmed that automotive interior skins with a tensile strength suitable for purpose may be selected and used as needed.

Through the above experimental examples, it was confirmed that the polymer composition for automotive interior skin according to the present disclosure may be manufactured with improved processability by recycling biomass materials without requiring a large amount of water. In addition, the automotive interior skin made from this not only can exhibit improved mechanical properties but also has enhanced aesthetics with a characteristic appearance of naturally derived materials.

Therefore, the polymer composition for automotive interior skin of the present disclosure and the automotive interior skin manufactured using the same may secure environmental friendliness by replacing some of the automotive interior skin composed of polymer materials derived from existing petroleum compounds with bio-based skin derived from biomass, and may expand the application of byproducts from the mushroom industry as valuable raw materials, while also contributing to environmental, social, and governance (ESG) goals.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A polymer composition for automotive interior skin, the polymer composition comprising:
a mushroom substrate powder;
a polymer resin;
stearic acid;
a metal oxide; and
a processing oil.

2. The polymer composition according to claim 1, wherein the polymer composition further comprises one or more selected from the group consisting of shaving scrap, an antioxidant, sulfur, and/or a vulcanization accelerator.

3. The polymer composition according to claim 1, wherein the mushroom substrate powder comprises, based on a total weight of the mushroom substrate powder, about 65 to 85 weight % of sawdust, about 5 to 20 weight % of rice bran, about 5 to 20 weight % of wheat bran, about 0.1 to 5 weight % of glucose, about 0.01 to 1 weight % of calcium, and about 0.01 to 1 weight % of shell powder.

4. The polymer composition according to claim 1, wherein the mushroom substrate powder has a cellulose content of about 25 to 60 weight % based on a total weight of the mushroom substrate powder.

5. The polymer composition according to claim 1, wherein the mushroom substrate powder has an average particle size of about 0.1 to 5 mm.

6. The polymer composition according to claim 1, wherein the polymer resin comprises one or more selected from the group consisting of ethylene propylene rubber (EPDM), ethylene vinyl acetate (EVA), polypropylene (PP), polyethylene terephthalate (PET), and/or thermoplastic elastomer (TPE).

7. The polymer composition according to claim 1, wherein the polymer composition comprises, based on 100 parts by weight of the mushroom substrate powder, about 50 to 500 parts by weight of the polymer resin, about 1 to 10 parts by weight of the stearic acid, about 1 to 30 parts by weight of the metal oxide, and about 5 to 50 parts by weight of the processing oil.

8. The polymer composition according to claim 2, wherein the polymer composition further comprises, based on 100 parts by weight of the mushroom substrate powder, about 50 to 200 parts by weight of the shaving scrap, about 1 to 10 parts by weight of the antioxidant, about 0.5 to 10 parts by weight of sulfur, and about 0.1 to 5 parts by weight of the vulcanization accelerator.

9. Automotive interior skin manufactured from the polymer composition for automotive interior skin according to claim 1.

10. The polymer composition according to claim 1, the mushroom substrate Spent mushroom substrate

11. A method of preparing a polymer composition for an automotive interior skin, the method comprising:
pulverizing a mushroom substrate to obtain a mushroom powder having an average particle size of about 0.1 to 5 mm,
mixing the mushroom substrate powder with a polymer resin, stearic acid, a metal oxide, and a processing oil in amounts corresponding to 100 parts by weight of the spent mushroom substrate powder, about 50 to 500 parts by weight of the polymer resin, about 1 to 10 parts by weight of the stearic acid, about 1 to 30 parts by weight of the metal oxide, and about 5 to 50 parts by weight of the processing oil to form a resulting mixture, and
forming the resulting mixture into a polymer composition.

12. The method of claim 11, wherein the mixture further comprises one or more selected from the group consisting of shaving scrap, an antioxidant, sulfur, and a vulcanization accelerator, in amount corresponding to 100 parts by weight of the mushroom substrate powder, about 50 to 200 parts by weight of the shaving scrap, about 1 to 10 pars by weight of the antioxidant, about 0.5 to 10 parts by weight of sulfur; and about 0.1 to 5 parts by weight of the vulcanization accelerator.

13. The method of claim 12, wherein the mushroom substrate powder is a spent mushroom substrate powder.

14. The method of claim 13, wherein the spent mushroom substrate powder comprises, based on a total weight of the spent mushroom substrate powder:
about 65 to 85 weight % of sawdust,
about 5 to 20 weight % of rice bran,
about 5 to 20 weight % of wheat bran,
about 0.1 to 5 weight % of glucose,
about 0.01 to 1 weight % of calcium, and
about 0.01 to 1 weight % of shell powder.

15. The method of claim 11, wherein the mushroom substrate powder has a cellulose content of about 25 to 60 weight % based on a total weight of the mushroom substrate powder.

16. An automotive interior skin manufactured by:
obtaining a polymer composition by the method of claim 11, and
molding or forming the polymer composition to produce the automotive interior skin.

17. The automotive interior skin of claim 16, wherein the automotive interior skin comprises about 1 to 50 weight % of the mushroom substrate powder based on the total weight of the automotive interior skin.

18. The automotive interior skin of claim 16, wherein the mushroom substrate is a spent mushroom substrate.

19. The automotive interior skin of claim 16, wherein the polymer composition further comprises about 50 to 200 parts by weight of shaving scrap.

20. The automotive interior skin of claim 16, wherein the polymer resins is one or more selected from the group consisting of ethylene propylene rubber (EPDM), ethylene vinyl acetate (EVA), polypropylene (PP), polyethylene terephthalate (PET), and thermoplastic elastomer (TPE).
